(19) United States
(12) Patent Application Publication
(10) Pub. No.: US 2026/0023296 A1
(43) Pub. Date: Jan. 22, 2026

(54) E-INK DISPLAY WITH EASILY MOUNTABLE AND DETACHABLE OUTER BEZEL

(71) Applicant: Shenzhen Joyhong Tech Co.,Ltd, Shenzhen (CN)

(72) Inventor: Jianping Wang, Shenzhen (CN)

(21) Appl. No.: 19/342,836

(22) Filed: Sep. 29, 2025

(30) Foreign Application Priority Data
Sep. 16, 2025 (CN) 202521989122.8

(51) Int. Cl. G02F 1/16753; G02F 1/167

(52) U.S. Cl. CPC G02F 1/16753; G02F 1/167

(57) ABSTRACT

An e-ink display with an easily mountable and detachable outer bezel is provided, including an e-ink display composed of a display screen assembly, a bottom housing, a surface housing, and a magnetic attraction assembly, and further including a quick-release replaceable decorative bezel. A plurality of upper clips and a plurality of lower clips are fixedly connected to an interior of each side of the replaceable decorative bezel. Since a first magnet cooperates with a second magnet that is embedded into a plastic plate in a groove, two magnet structures can implement quick attraction and fixation between the display and a mounting object, without relying on complex connection members such as bolts. Quick assembling and disassembling of the replaceable decorative bezel and a display main body are implemented, and a user can separately replace replaceable decorative bezels with different styles based on indoor environment changes.

### TECHNICAL FIELD

The present disclosure relates to the technical field of displays, and in particular, to an e-ink display with an easily mountable and detachable outer bezel.

### BACKGROUND

In indoor living and working scenarios, users often need to use fixed display devices such as TVs and displays at stationary positions (e.g., on a wall surface of a living room or beside a study desk of a study room). Due to the purchase costs, the mounting difficulty, and other factors, these devices typically have long replacement cycles and are often used for several years or even longer. However, indoor environments of the users are changing. As living demands have changed, cases such as decoration style evolution and house moving occur frequently. This puts forward new requirements for the display devices which not only need to have a simple appearance design that is not likely to cause a visual fatigue, but also need to adapt flexibly to diverse indoor environments to avoid the devices from being out of place with surrounding scenarios due to environment changes.

Although an e-ink display on the market is gradually put into use in an indoor regular usage scenario due to its advantages such as low power consumption and eye protection, the e-link display still has significant defects in its structural design:
1) Most e-ink displays have complex mounting manners, and are often fixed by bolts, assembled through brackets, or the like. These manners take long time for mounting. If a position needs to be adjusted or a mounting environment needs to be replaced subsequently, mounting and removal processes are tedious. It is hard to meet a requirement of a user for convenience.
2) An outer bezel of the display is mostly integrally formed with a main body structure and cannot be removed or replaced separately. When an interior decoration style is changed, the outer bezel with a fixed style does not match a new environment or a user needs to replace the entire display. This increases the usage costs and does not conform to a characteristic of long-time use of the display. Meanwhile, some devices have low stability after being fixed and easily move under slight collisions. This further reduces the user experience.

### SUMMARY

The present disclosure aims to provide an e-ink display with an easily mountable and detachable outer bezel, to solve the problems mentioned in the above background section.

In order to achieve the above objectives, the present disclosure provides the following technical solutions: an e-ink display with an easily mountable and detachable outer bezel, including an e-ink display. The e-ink display is composed of a display screen assembly, a bottom housing, a surface housing, and a magnetic attraction assembly; the display screen assembly is mounted inside the bottom housing and is pressed and fixed through the surface housing; and the magnetic attraction assembly is mounted on a back portion of the bottom housing and is fixed with a mounting object.

The e-ink display with the easily mountable and detachable outer bezel further includes a quick-release replaceable decorative bezel. A plurality of upper clips and a plurality of lower clips are fixedly connected to an interior of each side of the replaceable decorative bezel, and the upper clips and the lower clips are staggered in parallel; a top of the replaceable decorative bezel is fixedly connected with an inwards-folded edge; when the replaceable decorative bezel sleeves the bottom housing, the upper clips are buckled with a first buckling slot provided in an outer side of the surface housing; the lower clips are buckled with a ring slot buckling position provided in an outer side of the bottom housing; and the inwards-folded edge abuts against a top of the surface housing in a pressing manner.

In a preferred solution of the present disclosure, the display screen assembly is composed of an e-ink screen, a plastic spacer, a main board, a double-ended TYPE-C data cable, a control button, and a key board; the e-ink screen, the plastic spacer, the main board, the double-ended TYPE-C data cable, the control button, and the key board are mounted in corresponding mounting positions inside the bottom housing; a charging port and a button opening are formed in an outer side of the bottom housing; one end of the double-ended TYPE-C data cable and one end of the control button are respectively located inside the charging port and the button opening; and the control button is opposite to a key position of the key board.

In a preferred solution of the present disclosure, an inner side of the surface housing is fixedly connected with a plurality of reinforcing ribs; the inner side of the surface housing is fixedly connected with a plurality of plug-in pillars; and the plug-in pillars are plugged and fixed with plug-in seats fixedly connected to an inner side of the bottom housing.

In a preferred solution of the present disclosure, open slots are formed in positions, which are directly opposite to the charging port and the button opening, on the replaceable decorative bezel.

In a preferred solution of the present disclosure, the magnetic attraction assembly includes a boss fixedly connected to an interior of the bottom housing; a plurality of first magnets are fixedly embedded into the boss; the magnetic attraction assembly further includes a groove formed in a bottom of the bottom housing; a plastic plate is placed inside the groove; a plurality of second magnets are embedded into the plastic plate; and a back surface of the plastic plate is fixedly connected with a foam adhesive sheet.

In a preferred solution of the present disclosure, a back surface of the foam adhesive sheet is coated with a self-adhesive and is adhered with release paper.

In a preferred solution of the present disclosure, a battery located at a top of the boss is further mounted inside the bottom housing; a loudspeaker is further mounted at a side corner inside the bottom housing; and the battery and the loudspeaker are both electrically connected to the main board.

In a preferred solution of the present disclosure, a plurality of pressing blocks for fixing the e-ink screen are further mounted inside the bottom housing; and a plurality of foam blocks are adhered and cushioned in a gap between a back surface of the plastic spacer and the bottom housing.

Compared with the prior art, the present disclosure has the beneficial effects below:
1) Since the first magnets that are embedded into the boss inside the bottom housing cooperate with the second magnets that are embedded into the plastic plate in the groove, two magnet structures can implement quick attraction and fixation between the display and the mounting object, without relying on complex connection members such as bolts. The self-adhesive coated on the back surface of the foam adhesive sheet and the release paper can further improve the fixing stability. A user can complete preliminary adhesion by simply tearing off the release paper. Subsequent mounting and removal can be simply implemented by counteracting a magnetic attraction force. This greatly simplifies mounting and position adjustment procedures and solves the problems that the mounting and removal of the existing device are complex and it is hard to adapt to environment changes. By the arrangement of the quick-release replaceable decorative bezel, use of a buckled structure formed by the upper clips and the first buckling slot of the surface housing and a buckle structure formed by the lower clips and the ring slot buckling position of the bottom housing, and the use of the inwards-folded edge to press and fix the top of the surface housing, quick assembling and disassembling of the replaceable decorative bezel and a display main body are implemented, and a user can separately replace replaceable decorative bezels with different styles based on indoor environment changes, without replacing the entire display. This reduces usage costs, satisfies different clients, meets different usage needs, and perfectly matches a characteristic of long-time use of the device.
2) The plurality of reinforcing ribs on the inner side of the surface housing of the present disclosure can improve the structural strength of the surface housing and avoid deformation of the surface housing during long-term use. The plug-in pillars of the surface housing are plugged and fixed with the plug-in seats on the inner side of the bottom housing, which can ensure that the display screen assembly is firmly mounted inside the bottom housing and prevent looseness of the assembly due to collisions, thus solving the problem that the existing device has low stability after being fixed. Meanwhile, by the open slots that are formed in the positions, directly opposite to the charging port and the button opening, on the replaceable decorative bezel, a user does not need to worry about blocking the charging port and the control button when replacing the replaceable decorative bezel, thus ensuring normal use of charging and operating functions of the device, avoiding the impact of outer bezel replacement on basic functions of the device, providing convenience for subsequent maintenance, and further prolonging the overall service life of the device.

### BRIEF DESCRIPTION OF THE DRAWINGS

FIG. 1 is a schematic structural diagram of the present disclosure;

FIG. 2 is a first schematic structural diagram of the present disclosure;

FIG. 3 is a schematic structural diagram of a replaceable decorative bezel according to the present disclosure;

FIG. 4 is a first schematic structural diagram of a replaceable decorative bezel according to the present disclosure;

FIG. 5 is a schematic exploded diagram of the present disclosure; and

FIG. 6 is a first schematic exploded diagram of the present disclosure.

In the drawings: 100: e-ink display; 110: display screen assembly; 111: e-ink screen; 112: plastic spacer; 113: main board; 114: double-ended TYPE-C data cable; 115: control button; 116: key board; 120: bottom housing; 121: ring slot buckling position; 122: charging port; 123: button opening; 124: plug-in seat; 125: battery; 126: loudspeaker; 127: pressing block; 128: foam block; 130: surface housing; 131: first buckling slot; 132: reinforcing rib; 133: plug-in pillar; 140: magnetic attraction assembly; 141: boss; 142: first magnet; 143: groove; 144: plastic plate; 145: second magnet; 146: foam adhesive sheet; 147: release paper; 200: replaceable decorative bezel; 210: upper clip; 220: lower clip; 230: inwards-folded edge; and 240: open slot.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are some of the embodiments of the present disclosure rather than all the embodiments. Based on the embodiments of the present disclosure, all other embodiments obtained by those of ordinary skilled in the art without creative efforts fall within the protection scope of the present disclosure.

### Embodiment 1

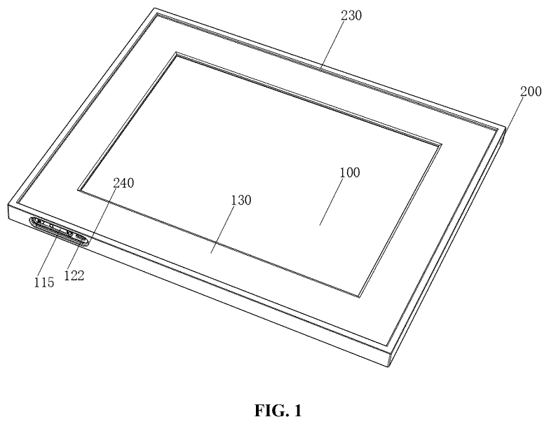

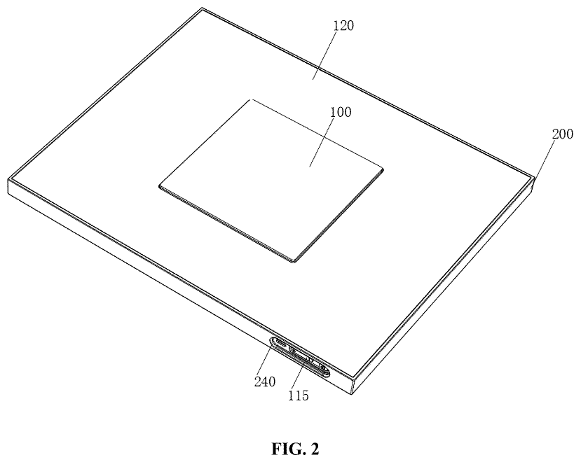

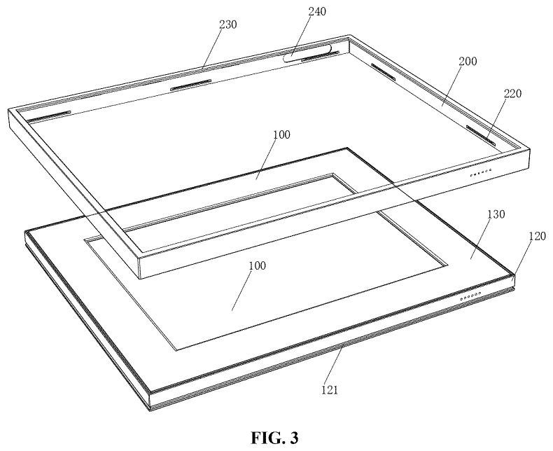

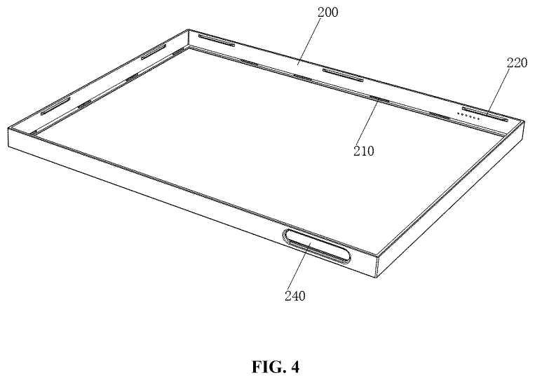

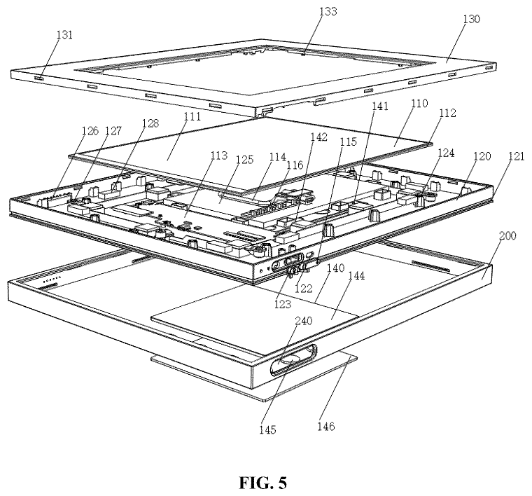

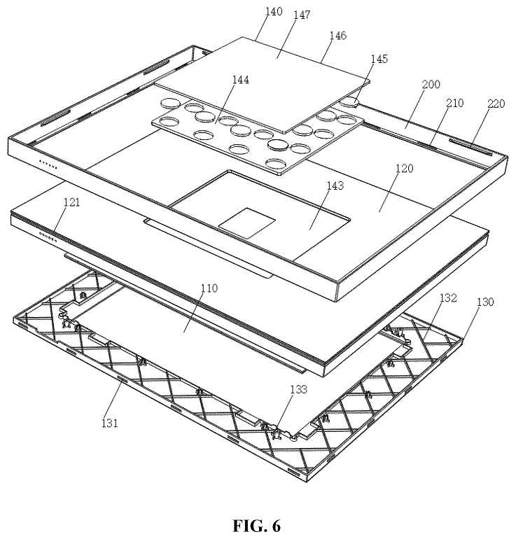

Referring to FIG. 1 to FIG. 6, the present disclosure provides a technical solution: An e-ink display with an easily mountable and detachable outer bezel includes an e-ink display 100. The e-ink display 100 is composed of a display screen assembly 110, a bottom housing 120, a surface housing 130, and a magnetic attraction assembly 140; the display screen assembly 110 is mounted inside the bottom housing 120 and is pressed and fixed through the surface housing 130; and the magnetic attraction assembly 140 is mounted on a back portion of the bottom housing 120 and is fixed with a mounting object.

The e-ink display with the easily mountable and detachable outer bezel further includes a quick-release replaceable decorative bezel 200. A plurality of upper clips 210 and a plurality of lower clips 220 are fixedly connected to an interior of each side of the replaceable decorative bezel 200, and the upper clips 210 and the lower clips 220 are staggered in parallel. A top of the replaceable decorative bezel 200 is fixedly connected with an inwards-folded edge 230. When the replaceable decorative bezel 200 sleeves the bottom housing 120, the upper clips 210 are buckled with a first buckling slot 131 provided in an outer side of the surface housing 130. The lower clips 220 are buckled with a ring slot buckling position 121 provided in an outer side of the bottom housing 120. The inwards-folded edge 230 abuts against a top of the surface housing 130 in a pressing manner.

Specifically, when a user mounts the e-ink display 100 in a fixed position such as on a wall surface of a living room or on a cabinet of a study room, the e-ink display 100 can be quickly fixed on the mounting object by using the magnetic attraction assembly 140 on the back portion, to meet a requirement of the user for long-term fixed placement of the device.

When the user has to replace the outer bezel because of a change in a decoration style, the replaceable decorative bezel 200 can be quickly mounted and detached through the upper clips 210 and the lower clips 220 in each side. During mounting, the replaceable decorative bezel 200 sleeves the bottom housing 120. The upper clips 210 can be clamped into the first buckling slot 131 on the outer side of the surface housing 130, and the lower clips 220 that are staggered with the upper clips 210 in parallel are clamped into the ring slot buckling position 121 of the bottom housing 120. Meanwhile, the inwards-folded edge 230 at the top is pressed to the top of the surface housing 130 to form a stable connection. During detaching, the clips can be separated from buckling positions by simply slightly pulling each side of the replaceable decorative bezel 200, and the entire process is tool-free. The user can easily change the style of the outer bezel based on a new environment, thus avoiding the device from being out of place with a surrounding environment.

When the replaceable decorative bezel 200 does not need to be used, the replaceable decorative bezel 200 can be directly removed. This will not affect the normal use of the e-ink display 100.

In this embodiment, the display screen assembly 110 is composed of an e-ink screen 111, a plastic spacer 112, a main board 113, a double-ended TYPE-C data cable 114, a control button 115, and a key board 116. The e-ink screen 111, the plastic spacer 112, the main board 113, the double-ended TYPE-C data cable 114, the control button 115, and the key board 116 are mounted in corresponding mounting positions inside the bottom housing 120. A charging port 122 and a button opening 123 are formed in an outer side of the bottom housing 120. One end of the double-ended TYPE-C data cable 114 and one end of the control button 115 are respectively located inside the charging port 122 and the button opening 123. The control button 115 is opposite to a key position of the key board 116.

Specifically, when a user uses the e-ink display daily, the e-ink screen 111 can be configured to display content. The plastic spacer 112 provides supporting and protection. The main board 113 controls overall operation. The double-ended TYPE-C data cable 114 can be directly connected to a power source. No component needs to be removed. When the device is operated, the control button 115 in the button opening 123 triggers a key of the key board 116 to implement a function such as switching and brightness adjustment. This is applicable to a long-term regular usage scenario and a scenario that requires easy maintenance.

In this embodiment, an inner side of the surface housing 130 is fixedly connected with a plurality of reinforcing ribs 132. The inner side of the surface housing 130 is fixedly connected with a plurality of plug-in pillars 133. The plug-in pillars 133 are plugged and fixed with plug-in seats 124 fixedly connected to an inner side of the bottom housing 120. Specifically, in a process of mounting the surface housing 130 or using the device for a long time by a user, the plurality of reinforcing ribs 132 on the inner side of the surface housing 130 can disperse the impact of an external force and enhance the overall strength of the surface housing 130, thus avoiding deformation of the surface housing due to daily collisions or pressing and protecting the display screen assembly 110 inside.

The surface housing 130 is formed into a multi-point fixed structure through the precise plugging between the plurality of plug-in pillars 133 and the plug-in seats 124 on the inner side of the bottom housing 120, so that the surface housing 130 and the bottom housing 120 are in close fit to prevent the problem of looseness, abnormal sounds, dust entering a gap, or the like during use.

In this embodiment, open slots 240 are formed in positions, which are directly opposite to the charging port 122 and the button opening 123, on the replaceable decorative bezel 200.

Specifically, when a user replaces a replaceable decorative bezel 200 with a different style based on an indoor environment, the open slots 240, which are directly opposite to the charging port 122 and the button opening 123, on the replaceable decorative bezel 200 can precisely avoid the charging port 122 and the button opening 123, so that it can ensure that a data cable can be still normally plugged into the charging port 122 outside the replaced replaceable decorative bezel 200, and the control button 115 inside the button opening 123 can also be smoothly operated. Basic functions of the device will not be affected due to the blockage of the outer bezel.

In this embodiment, the magnetic attraction assembly 140 includes a boss 141 fixedly connected to an interior of the bottom housing 120. A plurality of first magnets 142 are fixedly embedded into the boss 141. The magnetic attraction assembly 140 further includes a groove 143 formed in a bottom of the bottom housing 120. A plastic plate 144 is placed inside the groove 143. A plurality of second magnets 145 are embedded into the plastic plate 144. A back surface of the plastic plate 144 is fixedly connected with a foam adhesive sheet 146.

Specifically, when a user mounts the e-ink display 100, the plurality of first magnets 142 embedded into the boss 141 inside the bottom housing 120 magnetically attract the plastic plate 144 and the second magnets 145 embedded into the plastic plate 144 to prevent slippage of the device due to slight collisions. The foam adhesive sheet 146 on the back surface of the plastic plate 144 can achieve protection and buffering effects to avoid wear caused by direct contact between the magnets and a mounting plane.

In this embodiment, a back surface of the foam adhesive sheet 146 is coated with a self-adhesive and is adhered with release paper 147.

Specifically, when a user needs to fix the e-ink display 100 onto the mounting object such as a wall surface or a cabinet, the user first tears off the release paper 147 covering a surface of the self-adhesive. After a viscous surface is exposed, the foam adhesive sheet 146 is adhered to a mounting position, and the self-adhesive can quickly implement stable adhesion. With an attraction force of the magnets, a fixing effect is further enhanced, so that the mounting of the e-ink display can be quickly completed.

In this embodiment, a battery 125 located at a top of the boss 141 is further mounted inside the bottom housing 120. A loudspeaker 126 is further mounted at a side corner inside the bottom housing 120. The battery 125 and the loudspeaker 126 are both electrically connected to the main board 113.

Specifically, when a user mounts the e-ink display 100 at a position without a direct power interface, power can be independently supplied to the entire display through the battery 125, thus avoiding a limitation on a mounting position because of dependence of an external power source and meeting a requirement of the user for flexible arrangement. When the user uses the display to play back content with audios, the loudspeaker 126 can output sounds under signal control of the main board 113, without being additionally connected to an external sounding device, thus enhancing a comprehensive user experience.

In this embodiment, a plurality of pressing blocks 127 for fixing the e-ink screen 111 are further mounted inside the bottom housing 120. A plurality of foam blocks 128 are adhered and cushioned in a gap between a back surface of the plastic spacer 112 and the bottom housing 120.

Specifically, in assembling and long-term use processes of the display, the plurality of pressing blocks 127 can physically fix edges and key points of the e-ink screen 111 to prevent displacement or warping of the e-ink screen 111 due to vibrations, collisions, or temperature changes and avoid the impact on a viewing effect due to looseness of the screen. The plurality of foam blocks 128 can fill the gap by their elasticity characteristics to buffer the impact of external vibrations on components such as the plastic spacer 112 and the main board 113 inside. This can also avoid abnormal friction sounds caused by direct contact between the plastic spacer 112 and the bottom housing 120, and effectively prolong the service lives of the components inside.

Content that is not described in detail in this specification belongs to the existing technology known to those skilled in the art. Although the present disclosure has been described in detail with reference to the foregoing embodiments, those skilled in the art can still make modifications to the technical solutions described in the foregoing respective embodiments or make equivalent replacements to some technical features therein. Any modification, equivalent replacement, improvement, and the like made within the spirit and principle of the present invention shall fall within the protection scope of the present disclosure.

What is claimed is:

1. An e-ink display with an easily mountable and detachable outer bezel, comprising an e-ink display (100), wherein the e-ink display (100) is composed of a display screen assembly (110), a bottom housing (120), a surface housing (130), and a magnetic attraction assembly (140); the display screen assembly (110) is mounted inside the bottom housing (120) and is pressed and fixed through the surface housing (130); the magnetic attraction assembly (140) is mounted on a back portion of the bottom housing (120) and is fixed with a mounting object;
the e-ink display with the easily mountable and detachable outer bezel further comprises a quick-release replaceable decorative bezel (200); a plurality of upper clips (210) and a plurality of lower clips (220) are fixedly connected to an interior of each side of the replaceable decorative bezel (200), and the upper clips (210) and the lower clips (220) are staggered in parallel; a top of the replaceable decorative bezel (200) is fixedly connected with an inwards-folded edge (230); when the replaceable decorative bezel (200) sleeves the bottom housing (120), the upper clips (210) are buckled with a first buckling slot (131) provided in an outer side of the surface housing (130); the lower clips (220) are buckled with a ring slot buckling position (121) provided in an outer side of the bottom housing (120); and the inwards-folded edge (230) abuts against a top of the surface housing (130) in a pressing manner.

2. The e-ink display with the easily mountable and detachable outer bezel according to claim 1, wherein the display screen assembly (110) is composed of an e-ink screen (111), a plastic spacer (112), a main board (113), a double-ended TYPE-C data cable (114), a control button (115), and a key board (116); the e-ink screen (111), the plastic spacer (112), the main board (113), the double-ended TYPE-C data cable (114), the control button (115), and the key board (116) are mounted in corresponding mounting positions inside the bottom housing (120); a charging port (122) and a button opening (123) are formed in an outer side of the bottom housing (120); one end of the double-ended TYPE-C data cable (114) and one end of the control button (115) are respectively located inside the charging port (122) and the button opening (123); and the control button (115) is opposite to a key position of the key board (116).

3. The e-ink display with the easily mountable and detachable outer bezel according to claim 1, wherein an inner side of the surface housing (130) is fixedly connected with a plurality of reinforcing ribs (132); the inner side of the surface housing (130) is fixedly connected with a plurality of plug-in pillars (133); and the plug-in pillars (133) are plugged and fixed with plug-in seats (124) fixedly connected to an inner side of the bottom housing (120).

4. The e-ink display with the easily mountable and detachable outer bezel according to claim 2, wherein open slots (240) are formed in positions, which are directly opposite to the charging port (122) and the button opening (123), on the replaceable decorative bezel (200).

5. The e-ink display with the easily mountable and detachable outer bezel according to claim 2, wherein the magnetic attraction assembly (140) comprises a boss (141) fixedly connected to an interior of the bottom housing (120); a plurality of first magnets (142) are fixedly embedded into the boss (141); the magnetic attraction assembly (140) further comprises a groove (143) formed in a bottom of the bottom housing (120); a plastic plate (144) is placed inside the groove (143); a plurality of second magnets (145) are embedded into the plastic plate (144); and a back surface of the plastic plate (144) is fixedly connected with a foam adhesive sheet (146).

6. The e-ink display with the easily mountable and detachable outer bezel according to claim 5, wherein a back surface of the foam adhesive sheet (146) is coated with a self-adhesive and is adhered with release paper (147).

7. The e-ink display with the easily mountable and detachable outer bezel according to claim 5, wherein a battery (125) located at a top of the boss (141) is further mounted inside the bottom housing (120); a loudspeaker (126) is further mounted at a side corner inside the bottom housing (120); and the battery (125) and the loudspeaker (126) are both electrically connected to the main board (113).

8. The e-ink display with the easily mountable and detachable outer bezel according to claim 2, wherein a plurality of pressing blocks (127) for fixing the e-ink screen (111) are further mounted inside the bottom housing (120); and a plurality of foam blocks (128) are adhered and cushioned in a gap between a back surface of the plastic spacer (112) and the bottom housing (120).
